(19) United States
(12) Patent Application Publication
(10) Pub. No.: US 2007/0147056 A1
(43) Pub. Date: Jun. 28, 2007

(54) Headlight device and method for automotive vehicle

(75) Inventors: Toshio Sugimoto, Okazaki (JP); Ayako Goto, Nagoya (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/634,021

(22) Filed: Dec. 5, 2006

(30) Foreign Application Priority Data
Dec. 28, 2005 (JP) 2005-379369

(51) Int. Cl. F21V 1/00

(52) U.S. Cl. 362/466

(57) ABSTRACT

A headlight device for an automotive vehicle includes a headlight for lighting a forward area of the vehicle and a control unit. The control unit obtains a turning road curvature radius of a turning road in the forward area, sets a hypothetical radius larger than the specified curvature radius based on the specified curvature radius, and controls an optical axis direction of the headlight based on a swivel angle corresponding to the hypothetical radius in a predetermined zone short of an entrance of the turning road.

### CROSS REFERENCE TO RELATED APPLICATION

This application is based on Japanese Patent Application No. 2005-379369 filed on Dec. 28, 2005, the disclosure of which is incorporated herein by reference in its entirety.

### BACKGROUND OF THE INVENTION

1. Field of the Invention

The present invention relates to a headlight device and method for an automotive vehicle, in which an optical axis direction of a headlight can be swiveled in a horizontal direction.

2. Description of Related Arts

Conventionally, an adaptive front lighting system (AFS) is suggested, in which a light radiating direction of a headlight, i.e., optical axis, can be changed in accordance with a direction in which a driver wants to turn his/her eyes. The AFS has two functions, i.e., a leveling function (change in a vertical direction) and a swivel function (change in a horizontal direction).

In the swivel function, an actuator for changing the optical axis is driven to a swivel angle by a controller, when a calculation of the swivel angle is performed after a lighting signal, a vehicle speed and a steering angle are input into the controller. For example, the optical axis is changed in the right direction in a right turning road, and the optical axis is changed in the left direction in a left turning road. Therefore, a visibility in the vehicle moving direction can be improved when the vehicle is driven at night (e.g., U.S. Pat. No. 6,778,892 corresponding to JP-A-2003-72460).

However, in the conventional system, since the headlight optical axis is controlled to illuminate in the left/right direction based on the steering angle, a following problem may be caused. For example, in a case in which an automotive vehicle is driven along a road having a turning part ahead, when the vehicle is driven in a straight part before reaching the turning part, the vehicle driver is looking at the inner part of the turning road. Then, the driver starts changing the travel direction when the vehicle reaches close to the entrance of the turning part. Therefore, even if the optical axis is operated to illuminate the inner part of the turning road in accordance with the steering operation, the illuminating timing is delayed.

In view of this problem, JP-A-2002-52976 discloses a preceding swivel operation control, in which the optical axis is operated in the inner direction a little earlier by cooperation with a navigation device before the vehicle enters the turning road. According to this control, a place, at which a driver wants to look, can be illuminated by the headlight in advance, e.g., 3 seconds before reaching an entrance TRe of the turning road TR, as shown in FIG. 8. Thus, the visibility can be more improved. In FIG. 8, a case A1, in which the preceding swivel operation is performed, and a case A2, in which that is not performed, are shown. In the case A2, the headlight optical axis is controlled to illuminate in the right direction based on the steering angle. In the case A2, the preceding swivel operation is performed after determining a swivel angle based on a specified curvature radius R.

However, even if the preceding swivel operation is performed by the cooperation with the navigation device, a driver in a subject vehicle SV may feel a sense of discomfort by a rapid change of the headlight optical axis, and a driver in an oncoming vehicle OV may be dazzled, as shown in FIG. 8. These are because the optical axis is rapidly changed to the swivel angle based on the specified curvature radius R of the turning road TR when the vehicle SV is driven in the straight part of the road.

### SUMMARY OF THE INVENTION

In view of the foregoing and other problems, it is an object of the present invention to provide a headlight device and a method for an automotive vehicle, in which a preceding swivel operation of a headlight can be performed and a rapid change in an optical axis direction of the headlight can be reduced while the vehicle is driven in a straight part of a road.

According to an example of the present invention, a headlight device for an automotive vehicle includes a headlight for lighting a forward area of the vehicle. The device obtains a specified curvature radius of a turning road in the forward area, and sets a hypothetical radius larger than the specified curvature radius based on the specified curvature radius. The device then controls an optical axis direction of the headlight based on a swivel angle corresponding to the hypothetical radius in a predetermined zone short of an entrance of the turning road.

According to another example of the present invention, a headlight controlling method for an automotive vehicle includes an obtaining step, a setting step and a controlling step. In the method, a specified curvature radius of a turning road in the forward area is obtained, and a hypothetical radius larger than the specified curvature radius is set based on the specified curvature radius. Then, an optical axis direction of a headlight is controlled based on a swivel angle corresponding to the hypothetical radius in a predetermined zone short of an entrance of the turning road.

Accordingly, a visibility in the vehicle driver's sight direction can be improved since a rapid change of the optical axis direction can be reduced.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic view showing a system of a headlight device according to an embodiment of the present invention;

FIG. 2 is a flow diagram showing a preceding swivel controlling process according to the embodiment;

FIG. 3 is a pattern diagram showing an automotive vehicle moving toward a turning road according to the embodiment;

FIG. 4 is a graph showing a relationship between a distance from a starting point of a clothoid curve and a curvature radius of the clothoid curve according to the embodiment;

FIG. 5 is an example of a data map showing a relationship between a curvature radius and a swivel angle according to the embodiment;

FIGS. 6A-6C are pattern diagrams showing examples of optical axis directions of headlights changed by driving actuators according to the embodiment;

FIG. 7 is a reference table showing parameters of a clothoid curve according to the embodiment; and

FIG. 8 is a pattern diagram showing a preceding swivel operation in a conventional technology.

### DETAILED DESCRIPTION OF PREFERRED EMBODIMENT

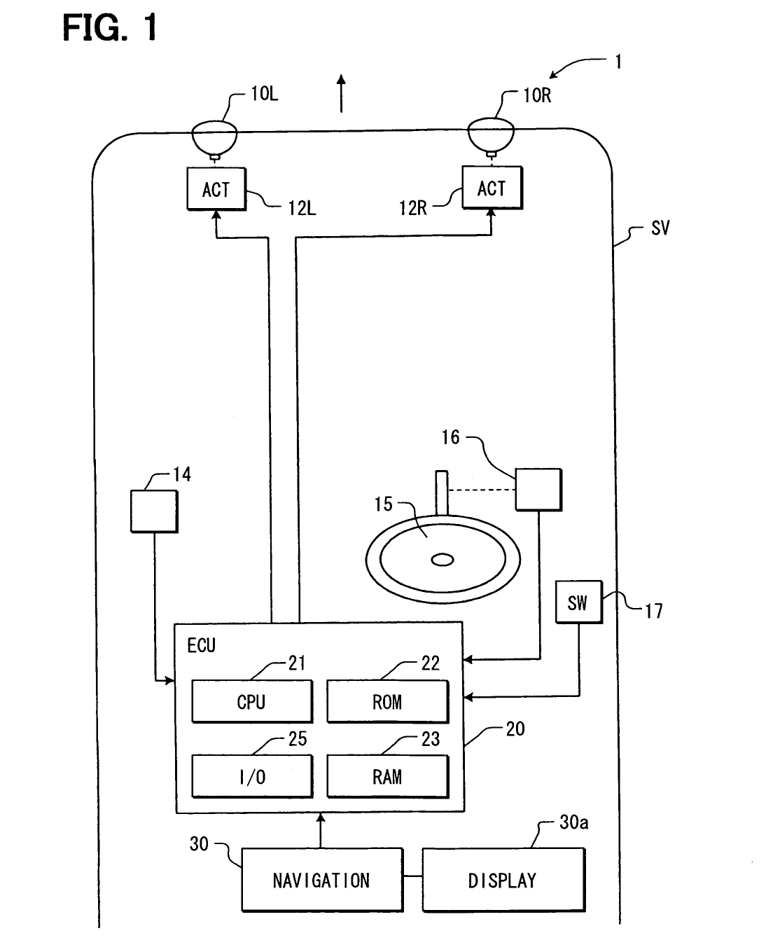

As shown in FIG. 1, an automotive vehicle (subject vehicle) SV has a left headlight 10L and a right headlight 10R provided in the front face. Inside of the vehicle, a headlight switch 17 for turning on/off the headlights 10L, 10R is provided. The headlights 10L, 10R provide a headlight device in this embodiment.

An electronic control unit (ECU) 20 includes a CPU 21, a ROM 22, a RAM 23 and an input/output circuit (I/O) 25 so that the ECU 20 is constructed as a controlling circuit for driving actuators 12L, 12R. The CPU 21 performs a variety of well-known arithmetic processes. A controlling program is stored in the ROM 22. A variety of data are stored in the RAM 23. The actuator 12L changes an optical axis of the headlight 10L, and the actuator 12R changes an optical axis of the headlight 12R.

A navigation device 30 includes a memory device (not shown) and a touch panel type display 30a. The memory device has road information, and the display 30a is disposed so as to be easily seen by a vehicle driver. The navigation device 30 predicts the vehicle position by using a global positioning system (GPS), and shows a map and the present vehicle position on the display 30a. The road information memorized in the navigation device 30 has information of a position, a length and a specified curvature radius of a turning road. Therefore, a turning road existing in the vehicle heading direction can be detected.

Output signals from a speed sensor 14, a steering angle sensor 16, the headlight switch 17, the output information from the navigation device 30, e.g., the position, the length and the specified curvature radius of the turning road, and other sensor signals are input into the ECU 20. The speed sensor 14 detects the vehicle speed. The steering angle sensor 16 detects a steering angle of a steering wheel 15.

The ECU 20 determines a target swivel angle by an arithmetic process based on the output signals from the speed sensor 14 and the steering angle sensor 16. The target swivel angle is an angle between the vehicle axis and the optical axis of the headlights 10L, 10R after the actuators 12L, 12R are driven. An output signal of the target swivel angle from the ECU 20 is input into the actuators 12L, 12R of the headlights 10L, 10R. Accordingly, the optical axis of the headlights 10L, 10R is adjusted to the driver's sight direction with the vehicle steering operation. The method for determining the swivel angle based on the vehicle speed and the steering angle is similar to a well-known conventional arithmetic process. Therefore, the description in detail will be omitted.

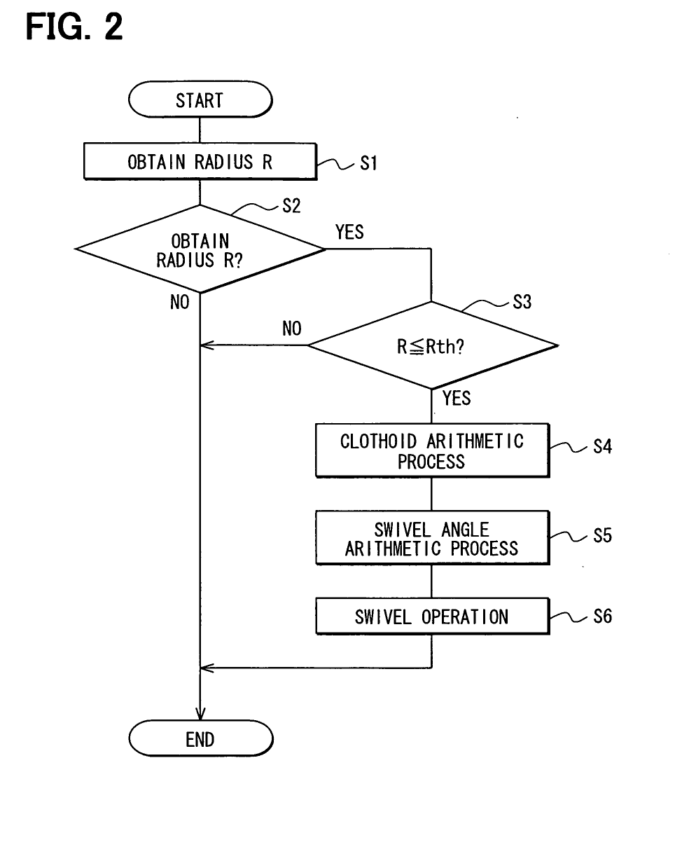

Next, a preceding swivel controlling process performed by the CPU 21 in the ECU 20 will be described with reference to FIG. 2. The content of the flow diagram shown in FIG. 2 is stored in the ROM 22 as a controlling program. The CPU 21 performs the program by reading from the ROM 22.

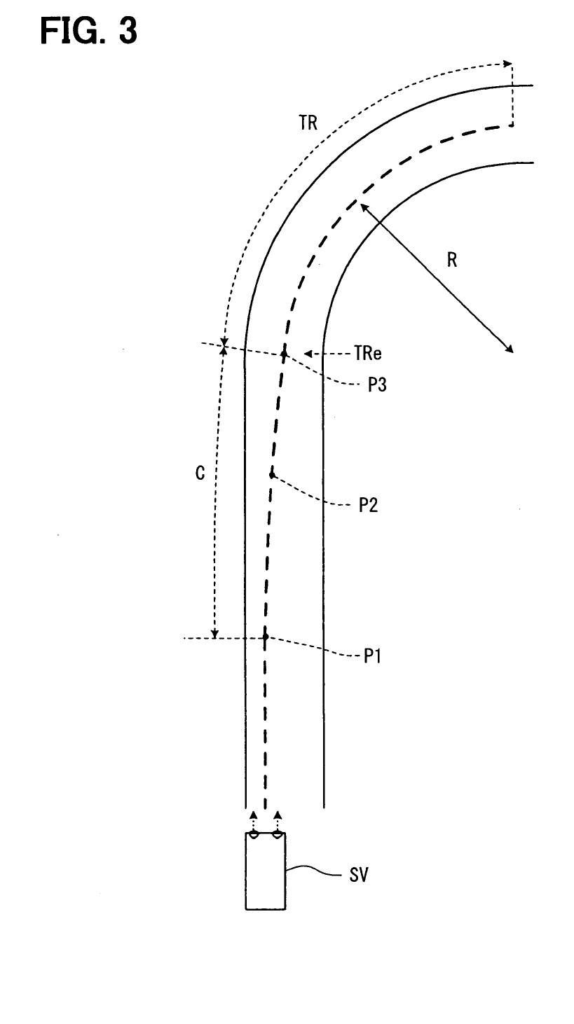

In the flow diagram shown in FIG. 2, firstly, information of a specified curvature radius R of a turning road in a forward area of the vehicle is obtained from the navigation device 30 (S1). The radius R is shown in FIG. 3. Next, a presence or absence of the information of the radius R is determined (S2). If the information is absent (S2: No), the process of the routine will be finished.

If the information is present (S2: Yes), the radius R is determined to be equal to or less than a threshold Rth or not (S3). For example, the threshold Rth is set to be 200 m. If the specified curvature radius R is more than the threshold Rth (S3: No), the process of the routine will be finished. In the case in which the radius R is more than the threshold Rth, the swivel operation of the headlights 10L, 10R is not performed, because the angle change of the driver sight is small when the vehicle enters a turning road having a relatively large radius R. Accordingly, the necessity of the swivel operation is low.

If the specified curvature radius R is equal to or less than the threshold Rth (S3: Yes), a clothoid arithmetic process is performed (S4). In the clothoid arithmetic process, a parameter and a curve length L of the clothoid curve C are calculated, in which the clothoid curve C is hypothetically connected to a turning road TR existing ahead of the vehicle SV, as shown in FIG. 3. Also, a curvature radius Rc at the vehicle position on the clothoid curve C is calculated in the clothoid arithmetic process. In addition, the clothoid curve C is a kind of easement curves, and is a track of the vehicle when the vehicle is whirled with a specified speed and a specified steering angle. The easement curve is a smoothly connecting curve between two roads. In the clothoid curve C, the curvature radius Rc and the curve length L are in inverse proportion, and the relationship between the radius Rc and the length L is defined as Rc*L=A² (A means a specified and is defined as a parameter).

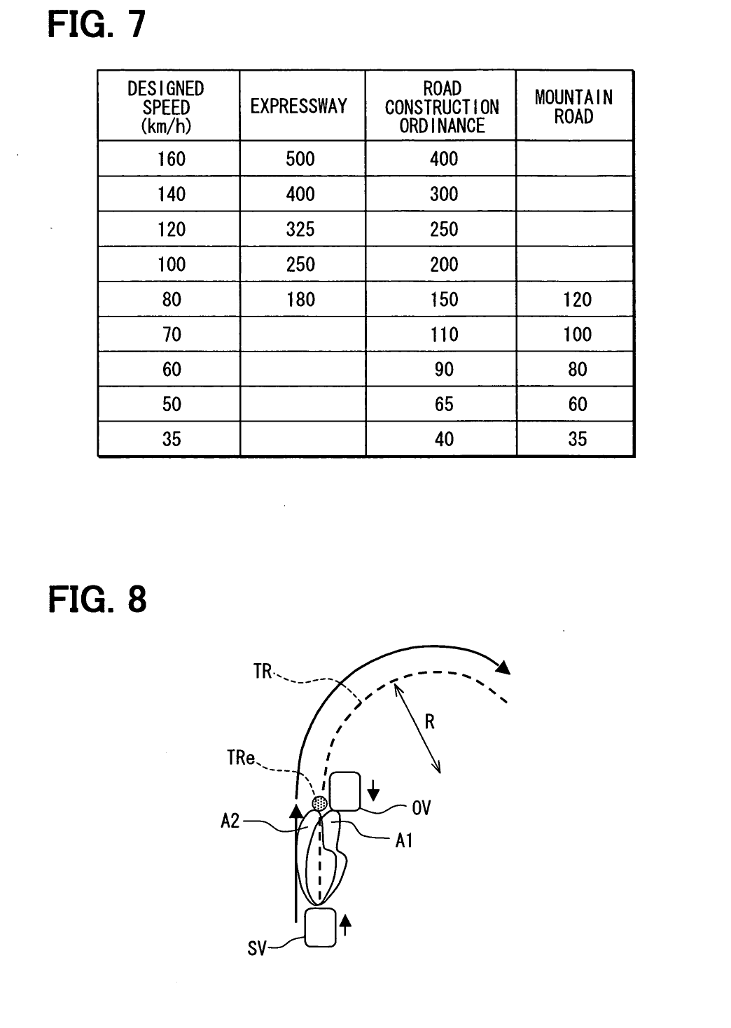

In the clothoid arithmetic process, firstly, the parameter A of the clothoid curve C corresponding to a designed speed for a turning road is determined by using a reference table shown in FIG. 7. For example, when the designed speed is set to be 60 km/h based on Road Construction Ordinance, the value of the parameter A is 90.

Next, the curve length L of the clothoid curve C is calculated in the formula L=A²/R by using the parameter A and the specified curvature radius R. For example, in the above example, in a case in which the radius R of the turning road is 70 m, the length L is calculated as L=90²/70≈115.7 m. As shown in FIG. 3, the clothoid curve C is hypothetically connected to the turning road TR.

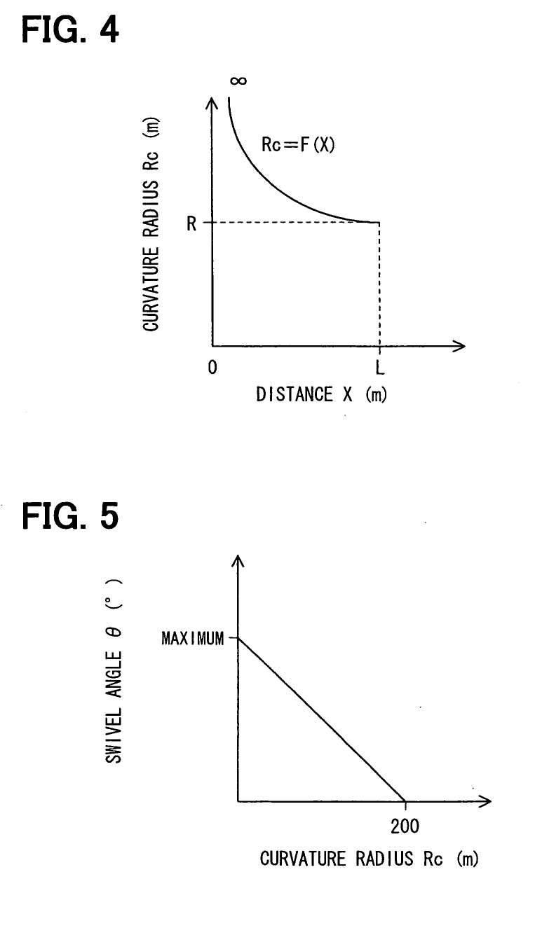

Then, the curvature radius Rc at the vehicle position on the clothoid curve C is calculated. The radius Rc can be expressed as a function of the distance X between the starting point P1 of the clothoid curve C and the vehicle position, e.g., Rc=F(X). The relationship between the distance X and the radius Rc can be expressed as the graph shown in FIG. 4. In addition, since the calculating method of the function F based on the parameter A and the curve length L is well known, the description of the method will be omitted.

At the starting point P1 of the clothoid curve C, the curvature radius Rc is calculated as Rc=F(0)=” (infinite). In contrast, at an ending point P3 of the clothoid curve C, which is an entrance TRe into the turning road TR, the curvature radius Rc is calculated as Rc=F(L)=R, as shown in FIG. 4. In the above example, the radius Rc of the curve C gradually decreases from infinite to 70 m when the vehicle moves from the starting point P1 to the ending point P3. The starting point P1 is positioned at 115.7 m back from the entrance TRe of the turning road TR, and the ending point P3 is the entrance TRe of the turning road TR.

Next, the swivel angle θ is determined based on the curvature radius Rc (S5 shown in FIG. 2). The swivel angle θ can be determined by a data map expressing a relationship between the curvature radius Rc and the swivel angle θ shown in FIG. 5, for example.

Lastly, the actuators 12L, 12R are driven based on the swivel angle θ determined in S5. Thus, the swivel operation of the headlights 10L, 10R are performed (S6), and the process of the routine will be finished.

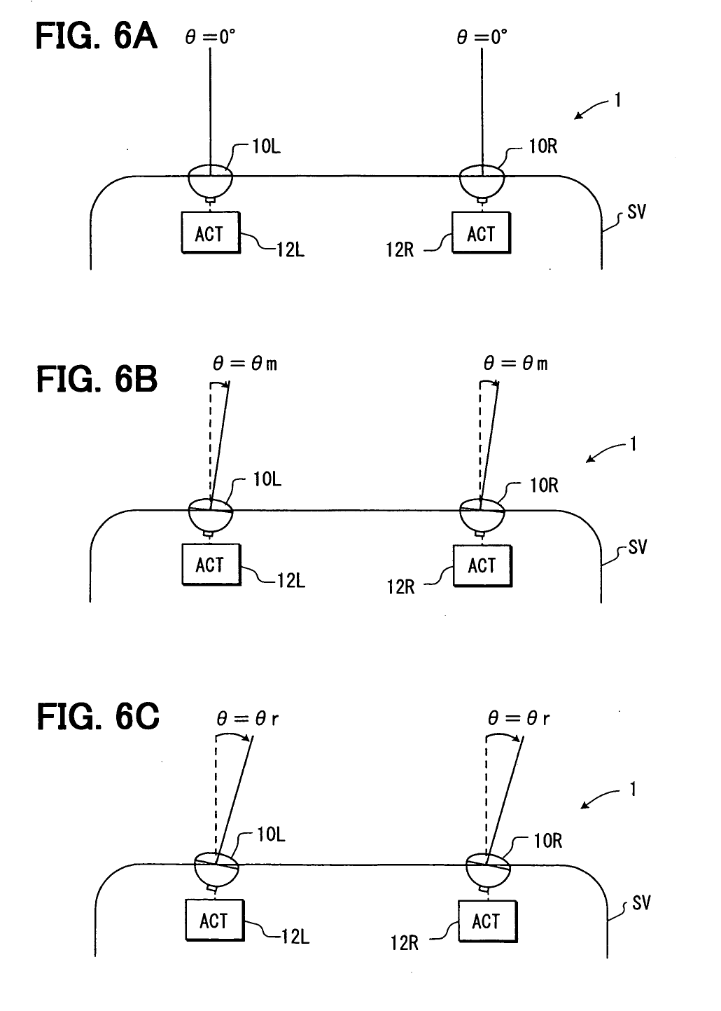

While the vehicle SV is driven in the straight part connected to the turning road TR, the routine is repeatedly performed. Thus, while the vehicle position moves closer to the entrance TRe of the turning road TR, the preceding swivel operation is repeatedly performed so that the swivel angle θ is gradually increased. That is, as shown in FIG. 6A, when the vehicle SV is positioned at the starting point P1 of the clothoid curve C shown in FIG. 3, the swivel angle is determined as θ=0. As shown in FIG. 6B, when the vehicle SV is positioned at the point P2 shown in FIG. 3, the swivel angle is determined as θ=θₘ (0<θₘ<θᵣ, θᵣ is a swivel angle corresponding to the specified curvature radius R). As shown in FIG. 6C, when the vehicle SV is positioned at the point P3, which is the entrance TRe, shown in FIG. 3, the swivel angle is determined as θ=θᵣ.

In the above embodiment, the process S1 functions to obtain a turning road curvature radius R, the process S4 functions to set a hypothetical radius Rc, and each of the processes S5, S6 functions to perform a preceding swivel control.

According to the embodiment, the specified curvature radius R of the turning road TR is obtained (S1 shown in FIG. 2), the hypothetic radius Rc, which is larger than the specified curvature radius R, is set based on the specified curvature radius R (S4), and the swivel operation of the headlights 10L, 10R is performed based on the swivel angle θ corresponding to the hypothetical radius Rc in the straight zone short of the entrance TRe of the turning road TR (S5-S6). Therefore, a rapid change of the optical axis direction of the headlights 10L, 10R can be reduced before the vehicle SV enters the turning road TR. Thus, a visibility in the direction of the driver's sight can be improved. Accordingly, it will be less likely that the driver feels a sense of discomfort by the rapid change of the optical axis direction of the headlights 10L, 10R, and that an oncoming driver is dazzled.

Especially, the clothoid curve C based on the specified curvature radius R and the designed speed of the turning road is hypothetically set in the straight zone as the easement curve capable of connecting to the turning road TR, and the curvature radius Rc at the vehicle position on the clothoid curve C is set as the hypothetical radius (S4). Therefore the swivel operation of the headlights 10L, 10R can be performed gradually in accordance with the shape of the easement curve hypothetically connected, i.e., the clothoid curve C, even if the easement curve is not practically connected to the turning road TR.

Moreover, the present invention is not limited to the embodiment, and a variety of changes can be performed in adherence with the spirit of the present invention.

For example, in the embodiment, the clothoid curve C capable of connecting to the turning road TR is hypothetically set in the straight zone, and the curvature radius Rc at the vehicle position on the clothoid curve C is set as the hypothetic radius. Alternatively, the hypothetic radius Rc may be set in an easier process. For example, in place of the process S4 in the flow diagram, a different predetermined arithmetic operation may be performed to the specified curvature radius R of the turning road TR, and the operated result may be set as the hypothetic radius Rc. Specifically, the specified curvature radius R multiplied by a predetermined coefficient specified equal to or more than one may be set as the hypothetic radius Rc. Alternatively, the specified curvature radius R added by a predetermined additional value equal to or more than zero may be set as the hypothetic radius Rc. According to the modified examples, the hypothetic radius Rc larger than the specified curvature radius R can be easily set without performing a complex arithmetic operation.

In addition, in the arithmetic operation, the predetermined coefficient specified and the predetermined additional value may be changed as long as the hypothetic radius Rc is gradually decreased when the vehicle moves closer to the entrance TRe of the turning road TR. In the straight zone, when the vehicle moves closer to the entrance TRe, the swivel angle θ is gradually increased, because the hypothetic radius Rc is gradually decreased. Thus, the rapid change of the optical axis direction of the headlights 10L, 10R can be reduced before entering the turning road TR. Accordingly, the visibility in the driver's sight can be surely improved.

Such changes and modifications are to be understood as being within the scope of the present invention as defined by the appended claims.

What is claimed is:

1. A headlight device for an automotive vehicle, the device comprising:
a headlight for lighting a forward area of the vehicle;
a turning road curvature radius obtaining means for obtaining a specified curvature radius of a turning road in the forward area;
a hypothetical radius setting means for setting a hypothetical radius larger than the specified curvature radius based on the specified curvature radius; and
a preceding swivel controlling means for controlling an optical axis direction of the headlight based on a swivel angle corresponding to the hypothetical radius in a predetermined zone short of an entrance of the turning road.

2. The headlight device according to claim 1, wherein:
the hypothetical radius setting means hypothetically sets an easement curve capable of connecting to the turning road in the predetermined zone, and
the hypothetical radius setting means sets a curvature radius as the hypothetical radius at the vehicle position on the easement curve.

3. The headlight device according to claim 2, wherein:
the easement curve is a clothoid curve determined based on the specified curvature radius of the turning road and a designed speed of the turning road.

4. The headlight device according to claim 1, wherein:
the hypothetical radius setting means performs a predetermined arithmetic calculation process to the specified curvature radius of the turning road and sets a result of the calculation process as the hypothetical radius.

5. The headlight device according to claim 1, wherein:
the hypothetical radius setting means gradually decreases the hypothetical radius when the vehicle position moves closer to the entrance of the turning road in the predetermined zone.

6. A headlight controlling method for an automotive vehicle, the method comprising:
obtaining a specified curvature radius of a turning road in a forward area of the vehicle;
setting a hypothetical radius larger than the specified curvature radius based on the specified curvature radius; and
controlling an optical axis direction of a headlight based on a swivel angle corresponding to the hypothetical radius in a predetermined zone short of an entrance of the turning road.

7. The method according to claim 6, wherein:
the setting of the hypothetical radius is performed at the vehicle position on an easement curve capable of connecting the turning road in the predetermined zone.

8. The method according to claim 7, wherein:
the easement curve is a clothoid curve determined based on the specified curvature radius of the turning road and a designed speed of the turning road.

9. The method according to claim 6, wherein:
in the setting of the hypothetical radius, a predetermined arithmetic calculation process is performed to the specified curvature radius of the turning road and a result of the calculation process is set as the hypothetical radius.

10. The method according to claim 6, wherein:
in the setting of the hypothetical radius, the hypothetical radius is gradually decreased when the vehicle position moves closer to the entrance of the turning road in the predetermined zone.

11. The method according to claims 6, wherein:
the swivel angle is determined based on a speed of the vehicle.

12. The method according to claim 6, wherein:
the predetermined zone is determined based on a speed of the vehicle and the specified curvature radius.
